(19) United States
(12) Patent Application Publication
(10) Pub. No.: US 2010/0026638 A1
(43) Pub. Date: Feb. 4, 2010

(54) ELECTRONIC DEVICE

(75) Inventor: WEI-JUN WANG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Taipei Hsien (TW)

(21) Appl. No.: 12/339,330

(22) Filed: Dec. 19, 2008

(30) Foreign Application Priority Data
Aug. 4, 2008 (CN) 200810303374.5

(51) Int. Cl. G06F 3/041

(52) U.S. Cl. 345/173

(57) ABSTRACT

An electronic device includes a main body, a touch panel positioned on the main body, and a shielding member movably and rotatably connected to the main body. The main body defines a recessed portion. The touch panel is positioned in the recessed portion. The recessed portion defines two sliding grooves in opposite sidewalls of the recessed portion. The shielding member defines two latches on opposite side surfaces of the shielding member. The two latches are movably inserted into the two sliding grooves respectively. The shielding member covers the touch panel in a first state and exposes the touch panel in a second state.

### BACKGROUND

1. Technical Field

The present disclosure generally relates to electronic devices and, more particularly, to an electronic device having a touch panel.

2. Description of Related Art

A typical electronic device such as a notebook computer, has a touch panel as a substitute for a mouse, to control the electronic device. The touch panel is positioned on an operation surface of a main body of the typical electronic device. When a display cover of the typical electronic device is opened, a user can input command via the touch panel.

However, the touch panel and a keyboard of the electronic device are both positioned on the same operation surface of the main body. When a user operates the keyboard, the touch panel is often touched inadvertently, thus introducing a misoperation and some trouble to the user. In addition, when the display cover of the electronic device is opened, the touch panel is always exposed, even if the touch panel is not being used. In addition, when the electronic device is used for a period of time, a control accuracy of the touch panel may decrease because of contamination caused by dust in an ambient environment, and the usage life of the touch panel may decrease because of abrasion caused by inadvertent collisions.

What is needed, therefore, is a new electronic device that overcomes the above mentioned disadvantages.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views, and all the views are schematic.

FIG. 1 is an isometric view of an embodiment of an electronic device, the electronic device including a shielding member and a touch panel.

FIG. 2 is a partial, exploded, isometric view of the electronic device in FIG. 1.

FIG. 3 is an isometric view of the shielding member of the electronic device in FIG. 1.

FIG. 4 is a partial, isometric view of the electronic device in FIG. 1, showing the touch panel exposed.

FIG. 5 is a partial, isometric view of the electronic device in FIG. 1, showing a touch panel covered by the shielding member.

### DETAILED DESCRIPTION OF THE EMBODIMENTS

The electronic device may be a notebook computer, a personal digital assistant, or a mobile phone. Hereinafter, for the purposes of conveniently describing the electronic device, an embodiment of a notebook computer is described and illustrated.

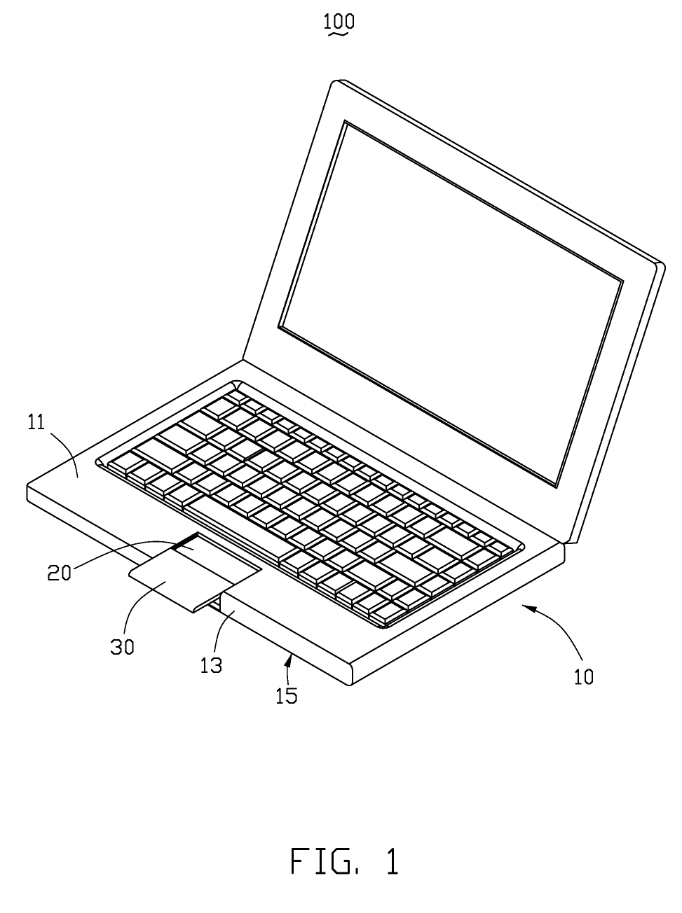

Referring to FIG. 1, a notebook computer 100 includes a main body 10, a touch panel 20 positioned on the main body 10, and a shielding member 30 to protect the touch panel 20.

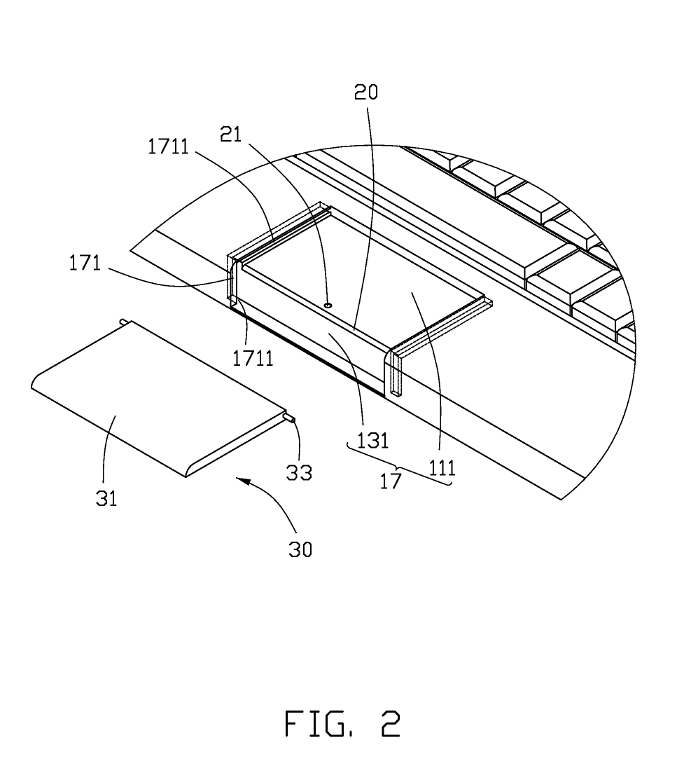

Referring also to FIG. 2, the main body 10 has a first surface 11, a second surface 13 adjoining the first surface 11, and a third surface 15 opposite the first surface 11. The first surface 11 defines a first recess 111, and the second surface 13 defines a second recess 131. The first recess 111 and the second recess 131 communicate with each other and cooperatively define a recessed portion 17. The recessed portion 17 includes two sliding grooves 1711 defined in opposite sidewalls 171 of the recessed portion 17. In the illustrated embodiment, the sliding grooves 1711 are both L-shaped.

The touch panel 20 is positioned in the first recess 111 of the main body 10. A latching hole 21 is defined in a top surface of the touch panel 20. In the illustrated embodiment, the latching hole 21 is substantially circular shaped.

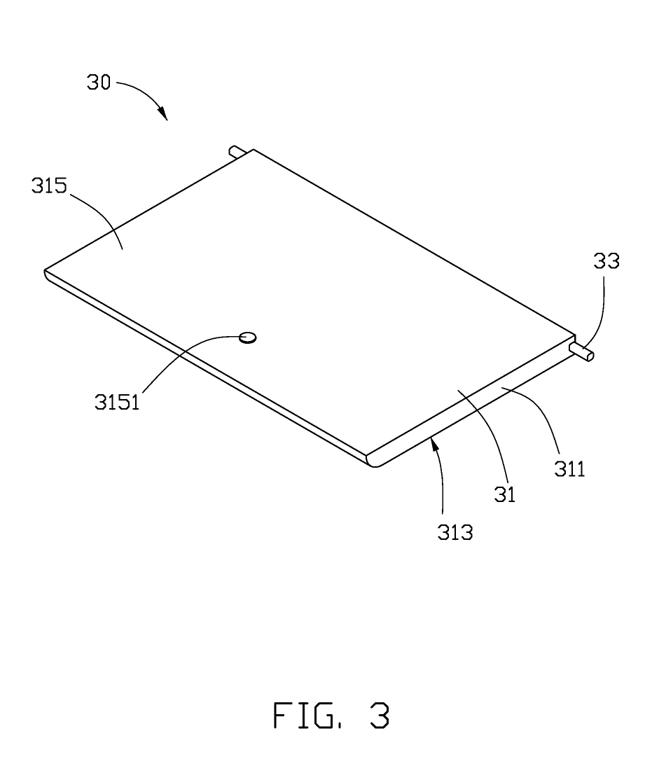

Referring to FIG. 3, the shielding member 30 includes a cover 31, and two latches 33 positioned on opposite side surfaces 311 of the cover 31. The cover 31 may be a substantially rectangular plate and has a top surface 313, and a bottom surface 315 opposite to the top surface 313. A latching protrusion 3151 is formed on the bottom surface 315 corresponding to the latching hole 21 of the touch panel 20, and configured to be inserted into the latching hole 21. In the illustrated embodiment, the latching protrusion 3151 is substantially circular shaped. In another embodiment, the latching protrusion 3151 of the shielding member 30 may be other suitable shaped protrusions, such as a cylindrical protrusion, or a hemispherical protrusion. Each latch 33 may be substantially shaped like a cylinder. The latches 33 are configured to be movably and rotatably inserted into the two sliding grooves 1711 respectively, so that the shielding member 30 is movably and rotatably connected with the main body 10.

In another embodiment, the sliding groove 1711 may have a latching portion defined in the sliding groove 1711. The hook of the latch 33 latches with the latching portion of the sliding groove 1711 to prevent the shielding member 30 from detaching from the main body 10.

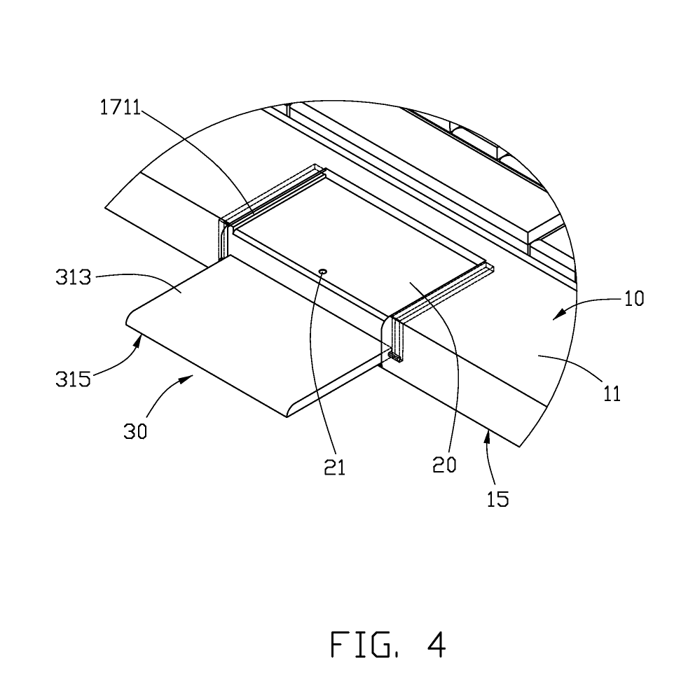

Referring to FIG. 4, the touch panel 20 may be exposed by applying an external force on the shielding member 30, so that the shielding member 30 is moved upwards, and the latching protrusion 3151 is detached from the latching hole 21. The cover 31 is moved outwards, pulling the latches 33 to slide along the sliding grooves 1711 until the latches 33 become blocked by first ends of the sliding grooves 1711 adjacent to the third surface 15 of the main body 10. Thus, the touch panel 20 can be operated to input data.

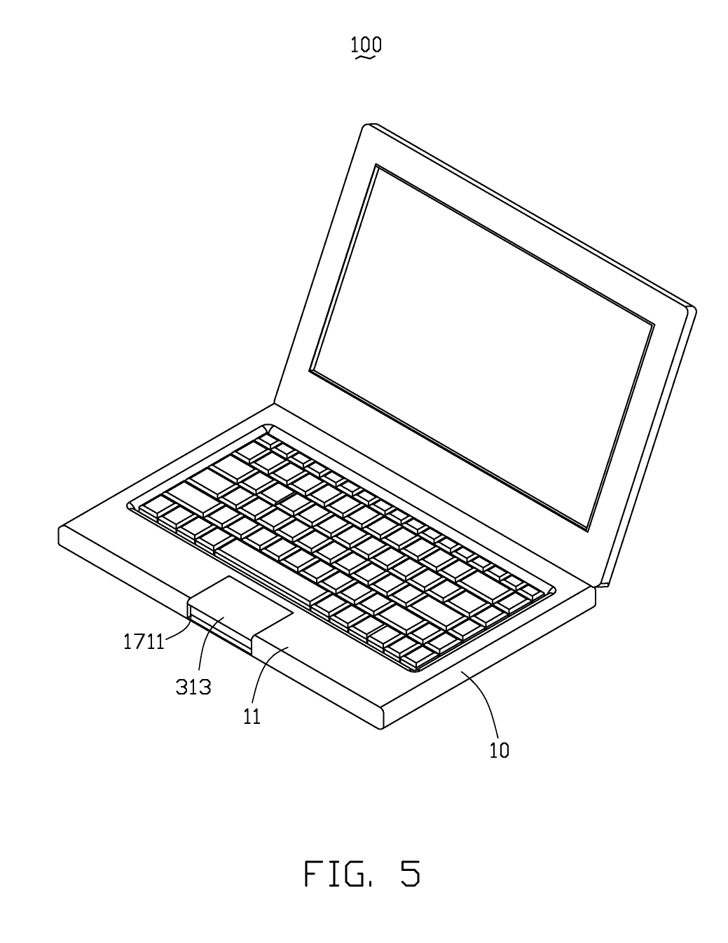

Referring to FIG. 5, the touch panel 20 may be covered by applying an external force on the cover 31, so that the cover 31 is moved upwards, pulling the latches 33 to slide along the sliding grooves 1711 until the latches 33 become blocked by second ends of the sliding grooves 1711 positioned in the first surface 11 of the main body 10. The cover 31 is pressed until the latching protrusion 3151 is inserted into the latching hole 21, thus preventing the cover 31 from sliding out of the recessed portion 17. The touch panel 20 is now completely covered by the shielding member 30. When a keyboard of the notebook computer 100 is operated, the shielding member 30 guards the touch panel 20 from any inadvertent input operations. The shielding member 30 can also protect the touch panel 20 from collecting dust from the ambient environment, or abrasion caused by inadvertent collisions. As a result, the touch panel 20 will have a high control accuracy and a long usage life. In addition, the shielding member 30 is a simple structure and convenient to use. When the touch panel 20 is covered by the shielding member 30, the top surface 313 of the shielding member 30 is substantially coplanar with the first surface 11 of the main body 10, so the notebook computer 100 has a good appearance.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. An electronic device, comprising:
a main body;
a touch panel positioned on the main body; and
a shielding member movably and rotatably connected to the main body adjacent to the touch panel, the shielding member covers the touch panel in a first state and exposes the touch panel in a second state.

2. The electronic device of claim 1, wherein the main body comprises a first recess defined in one surface of the main body and a second recess defined in an adjacent surface of the main body; the first recess and the second recess communicate with each other and cooperatively define a recessed portion; the touch panel is positioned in the first recess.

3. The electronic device of claim 2, wherein two sliding grooves are defined in opposite sidewalls of the recessed portion; the shielding member comprises a cover, and two latches positioned on opposite side surfaces of the cover, the two latches are movably and rotatably inserted into the two sliding grooves respectively.

4. The electronic device of claim 3, wherein the sliding grooves are L-shaped, each of the latches is substantially shaped like a cylinder.

5. The electronic device of claim 1, wherein the touch panel defines a latching hole in a top surface thereof, the shielding member comprises a latching protrusion formed on a bottom surface thereof corresponding to the latching hole.

6. The electronic device of claim 1, wherein when the shielding member is moved to cover the touch panel in the first state, a top surface of the shielding member is coplanar with a top surface of the main body.

7. An electronic device, comprising:
a main body comprising a recessed portion, opposite sidewalls of the recessed portion defining two sliding grooves therein;
a touch panel positioned in the recessed portion of the main body; and
a shielding member movably and rotatably connected to the main body, the shielding member comprising two latches formed on opposite side surfaces thereof, the latches being movably inserted into the sliding grooves respectively, the shielding member covers the touch panel in a first state and exposes the touch panel in a second state.

8. The electronic device of claim 7, wherein the recessed portion comprises a first recess defined in one surface of the main body and a second recess defined in an adjacent surface of the main body, the first recess and the second recess communicate with each other.

9. The electronic device of claim 7, wherein the touch panel defines a latching hole in a top surface thereof, the shielding member comprises a latching protrusion formed on a bottom surface thereof corresponding to the latching hole.

10. The electronic device of claim 7, wherein the electronic device is a notebook computer.
